(19) United States
(12) Patent Application Publication
(10) Pub. No.: US 2019/0257368 A1
(43) Pub. Date: Aug. 22, 2019

(54) WET MULTI-PLATE CLUTCH

(71) Applicant: SCHAEFFLER TECHNOLOGIES AG & CO. KG, HERZOGENAURACH (DE)

(72) Inventors: Oliver NOEHL, Buehlertal (DE); Philipp TEPPER, Buehl (DE)

(73) Assignee: SCHAEFFLER TECHNOLOGIES AG & CO. KG, HERZOGENAURACH (DE)

(21) Appl. No.: 16/323,466

(22) PCT Filed: Nov. 3, 2017
(86) PCT No.: PCT/DE2017/100931

§ 371 Date: Feb. 5, 2019

(30) Foreign Application Priority Data
Nov. 16, 2016 (DE) 10 2016 222 472.7

(51) Int. Cl. F16D 13/64; F16D 65/54; F16D 13/72

(52) U.S. Cl. CPC F16D 13/648; F16D 65/543; F16D 2069/005; F16D 2013/642; F16D 13/72

(57) ABSTRACT

A wet multi-plate clutch comprising a first friction plate including a first carrier element with a first carrier element thickness, wherein the first friction plate further includes a first friction pad attached thereto, wherein the friction pad includes friction pad segments, between which parallel fluid channels are formed, wherein the first friction pad includes a first friction pad thickness, wherein the ratio of the friction pad thickness to the first carrier element thickness is between 0.25 and 0.85, and a second friction plate including a second carrier element with a second carrier element thickness.

### CROSS-REFERENCE TO RELATED APPLICATIONS

This application is the U.S. National Phase of PCT/DE2017/100931 filed Nov. 3, 2017, which claims priority to DE 102016222472.7 filed Nov. 16, 2016, the entire disclosures of which are incorporated by reference herein.

### TECHNICAL FIELD

The disclosure relates to a wet multi-plate clutch with friction plates, each of which comprises a carrier element with a carrier element thickness and to which at least one friction pad is attached that has a friction pad thickness.

### BACKGROUND

A friction pad for a device for transferring torque, in particular a frictional clutch, is known from the European patent application EP 0 669 482 A2, which can be attached to a carrier element to form a friction surface and transfers the torque to a counter-surface, wherein the friction pad is constructed of at least two different, porous layers, one of which is attached to the carrier element, and forms a porous sub-layer with a cellulous base comprised of plastic fibers and filler material, for a likewise porous friction layer attached to it, produced from thermosetting fibers, wherein the friction layer has a weight of 10 to 120 g/m², and a thickness of 0.02 to 0.3 mm. A wet multi-plate clutch with two or more annular plates disposed in rows and subjected to a flow of coolant is known from the German patent application DE 10 2009 000 431 A1, which are alternately formed as uncoated steel plates and a friction pad plates, or steel plates with a friction pad on just one side, that have an alternating outer and inner toothing for connecting to an outer and an inner plate carrier, wherein the steel plates each have a first and second annular friction surface that bear on an intermediate ring disposed therebetween, which is elastic and can be deformed, and allows the coolant to pass through it, and which are connected to on another at their inner and outer edges such that they can move axially, and in which coolant entry and exit holes are exposed, wherein the uncoated friction plate can be deformed due to a reduced thickness, wherein the thickness of the friction plate that can be deformed elastically and is uncoated is between ten and twenty percent of the thickness of conventional, massive steel plates. A friction material with a friction modification layer is known from the German translation DE 603 09 396 T2 of the European patent EP 1 396 665 B1, with an average thickness of thirty to approximately two hundred micrometers.

### SUMMARY

The object of the disclosure is to improve a wet multi-plate clutch with friction plates, each of which comprises a carrier element with a carrier element thickness and to which at least one friction pad is attached, which has a friction pad thickness, in particular with respect to its axial installation space.

The problem may be solved with a wet multi-plate clutch that has friction plates, each of which comprises a carrier element with a carrier element thickness and to which at least one friction pad is attached with a friction pad thickness, in that the ratio of the friction pad thickness to the carrier element thickness is 0.25 to 0.85. The carrier element is a carrier plate, for example, with an internal or external radial toothing for obtaining a connection to a plate carrier of the multi-plate clutch for conjoint rotation therewith. The carrier element thickness refers to the axial dimension of the carrier element. The term “axial” relates to a rotational axis of the multi-plate clutch. The axial direction is parallel to the rotational axis. Analogously, the friction pad thickness refers to the axial dimension of the friction pad. The friction pad thickness varies advantageously between 0.25 millimeters and 0.6 millimeters. The carrier plate thickness is derived from the friction pad thickness divided by the carrier element thickness and is advantageously between 0.9 millimeters and 0.7 millimeters. For carrier elements with a carrier element thickness of 0.9 millimeter, 0.8 millimeters, 0.7 millimeters, friction pad thicknesses of 0.25, 0.3, 0.4, 0.5, 0.6 and 0.65 millimeters have proven to be particularly advantageous in tests and studies carried out in the framework of the present disclosure.

Another exemplary embodiment of the wet multi-plate clutch may include a carrier element that has friction pads on two opposing sides. The friction pads on the opposing sides of the carrier element are advantageously of the same thickness. The friction pads can be single or multi -part friction pads.

Another exemplary embodiment of the wet multi-plate clutch may include friction plates that are disposed radially, and alternate with counter-plates along the axial direction. The counter-plates are advantageously formed by steel plates without friction pads. The term “axial” likewise refers to the rotational axis of the multi-plate clutch. “Radial” refers to the direction transverse to the rotational axis of the multi-plate clutch.

Another exemplary embodiment of the wet multi-plate clutch is characterized in that the multi-plate clutch is an axial double clutch. The axial double clutch comprises two sub-clutches in the form of multi-plate clutches, which are axially offset to one another. The sub-clutches overlap radially, such that they are not nested in one another. This results in a relatively large axial installation space required by the two sub-clutches in the axial double clutch. By using the proposed ratios of the friction pad thickness to the carrier element thickness, a sufficient functionality of the double clutch can also be ensured with relatively thin friction pads.

An object of the disclosure described above is alternatively or additionally solved with a wet multi-plate clutch that has friction plates, each of which comprises a carrier element with a carrier element thickness, and to which the at least one friction pad is attached, which has a friction pad thickness, in particular with a wet multi-plate clutch as described above, in that the friction pad comprises friction pad segments with parallel fluid channels formed therebetween. The friction pad segments are relatively narrow in the circumferential direction. The parallel fluid channels advantageously tend to be wider and/or deeper than conventional grooves. As a result, an equivalent or similar flow-through speed to that with conventional multi-plate clutches can be obtained. In this manner, undesired negative effects on the function of the multi-plate clutch, in particular in the form of drag torques, insufficient cooling, or in the form of hydroplaning effects, can be avoided.

Another exemplary embodiment of the wet multi-plate clutch may include friction pad segments that extend continuously from the radial inside to the radial outside. This results in an unimpaired flow along the carrier element between to respective friction pad segments.

Another exemplary embodiment of the wet multi-plate clutch may have friction pad segments that are less than half the size along the circumference than in the radial direction. A ratio of the size in the radial direction to the size along the circumference of less than 3:1 has proven to be advantageous in tests and studies carried out in the framework of the disclosure.

Another exemplary embodiment of the wet multi-plate clutch may have fluid channels that run in the radial direction. The term “radial” relates to the rotational axis of the multi -plate clutch. “Radial” is transverse to the rotational axis.

Another exemplary embodiment of the wet multi-plate clutch may have fluid channels that are at an angle, or diagonal to the a radial axis. The course of the fluid channels is advantageously slanted such that a fluid, e.g. a coolant or cooling fluid deviates from the radial direction, depending on the rotational direction of the plates, in order to distribute fluid, in particular cooling fluid, over the circumference in a targeted manner. This results in a larger area over which the fluid flows than with a purely radial configuration of the fluid channels. As a result of an angle or bend in the fluid channels, an optimal compromise can be obtained between a quick flow-through, which is good for low drag torques, and the largest possible steel plate surface over which the fluid flows, thus improving the overall cooling effect.

The disclosure also relates to a friction plate for the wet multi-plate clutch described above. The friction plate can be dealt with separately.

### BRIEF DESCRIPTION OF THE DRAWINGS

Further advantages, features and details of the disclosure can be derived from the following description, in which various exemplary embodiments are described in detail with reference to the drawings. Therein:

FIG. 1 shows a simplified sectional view of an axial double-clutch with two sub -clutches in the form of multi-plate clutches;

FIG. 2 shows an enlarged detail of FIG. 1, with two multi-plate packets, interconnected axially;

FIG. 3 shows a detail of a section of a friction plate;

FIG. 4 shows a simplified illustration of various friction pads for the friction plates in FIG. 3, viewed from above; and

FIG. 5 shows an enlarged detail of a section of FIG. 4, wherein the illustration is not to scale, or is independent of the thickness of the friction pad.

### DETAILED DESCRIPTION

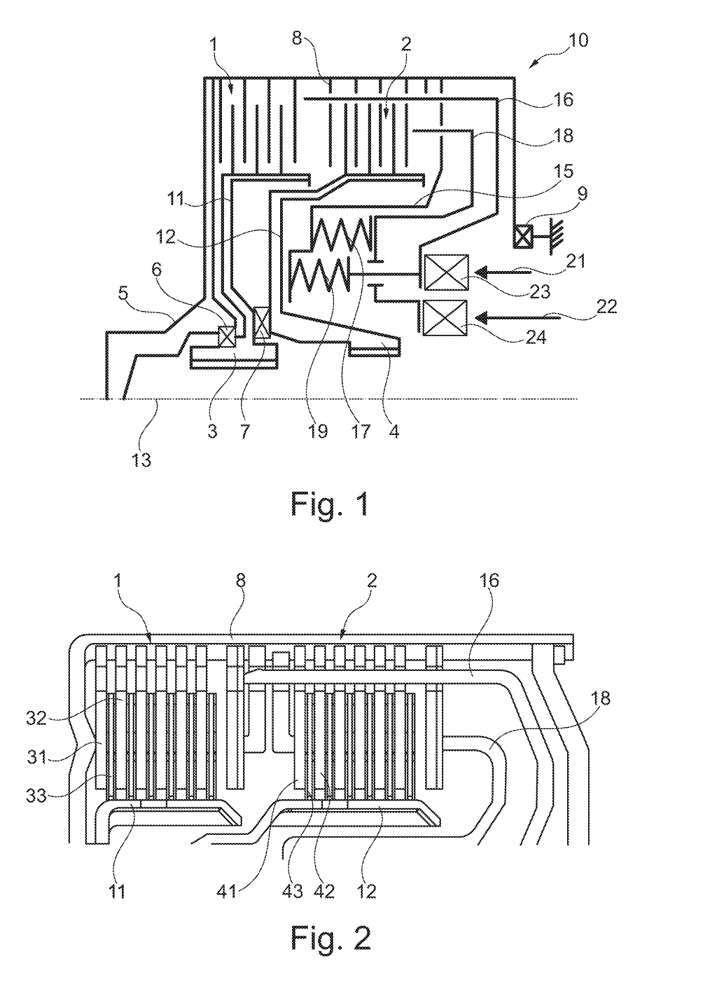

An axial double-clutch 10 that has two sub-clutches 1, 2 interconnected axially is shown in a simplified manner in FIG. 1. The sub-clutches 1, 2 are in the form of wet multi-plate clutches. “Wet” may mean that the multi-plate clutches 1, 2 are supplied with a cooling medium, such as coolant, also referred to as fluid, for the cooling thereof.

The multi-plate clutch 1 comprises a hub 3, which can be connected to a transmission input shaft (not shown) for conjoint rotation therewith. The multi-plate clutch 2 comprises a hub 4, which can be connected to a second, preferably hollow, transmission input shaft (likewise not shown) for conjoint rotation therewith.

The two multi-plate clutches 1, 2 comprise a common input element 5. The input element 5 is connected to a drive shaft (not shown) for conjoint rotation therewith. A bearing mechanism 6 is located between the input element 5 and the hub 3 of the multi-plate clutch 1. Another bearing mechanism 7 is located between the two hubs 3, 4 of the multi-plate clutches 1, 2.

The input element 5 of the double-clutch 10 is connected to a common outer plate carrier 8 for both multi-plate clutches 1, 2 for conjoint rotation therewith. The outer plate carrier 8 is rotatably supported in relation to a stationary housing by a bearing mechanism 9. The stationary housing is only indicated symbolically in the bearing mechanism 9.

The multi-plate clutch 1 comprises an inner plate carrier 11, which is connected to the hub 3 for conjoint rotation therewith. The multi-plate clutch 2 comprises an inner plate carrier 12, which is connected to the hub 4 for conjoint rotation therewith. A rotational axis of the double -clutch 10 is indicated by a broken line 13 comprising dots and dashes. The hubs 3, 4 can rotate about the rotational axis 13, in relation to one another and in relation to the outer plate carrier 8.

A support element 15 is attached to the outer plate carrier 8, which extends radially inward in steps from the outer plate carrier 8. The support element 15 axially supports actuating elements 16, 18 with spring elements 17, 19.

The actuating element 16 actuates the multi-plate clutch 1, and extends through a plate packet of the multi-plate clutch 2. The actuating element 18 actuates the multi-plate clutch 2.

An actuating force is indicated by the arrow 21, which is applied to the actuating element 16 via an actuator bearing 23 in order to actuate the multi-plate clutch 1. An actuating force is indicated by the arrow 22, which is applied to the actuating element 18 via an actuator bearing 24 in order to actuate the multi-plate clutch 2.

As indicated by arrows 21, 22, the axially nested wet multi-plate clutch 10 shown in a simplified manner in FIG. 1, is actuated from one side, the right-hand side in FIG. 1, with a reach-through for actuating the multi-plate clutch 1. With such axial double-clutches, in which the individual multi-plate clutches 1, 2 are located axially behind one another, the thickness of the individual plates is of decisive significance for making do with the axial installation space that is available.

The detail of FIG. 1 in FIG. 2 shows that the first multi-plate clutch 1 has a total of seven outer plates 31, 32, and a total of six friction plates 33. The outer plates 31, 32 and the friction plates 33 are arranged in an alternating manner in a plate packet such that there is one friction plate 33 between each pair of two outer plates 31, 32.

The multi-plate clutch 2 comprises a plate packet that is axially adjacent to the plate packet of the multi-plate clutch 1 with a total of seven outer plates 41, 42 and six friction plates 43. The outer plates 41, 42 alternate with the friction plates 43 in the right-hand plate packet of the multi-plate clutch 2 in FIG. 2 in exactly the same manner as the plates in the left-hand plate packet of the multi-plate clutch 1 in FIG. 2.

The outer plates 31, 32 and 41, 42 of the multi-plate clutches 1, 2 are steel plates. With the thickness of the steel plates, a lower limit that cannot be exceeded is obtained through the necessary heat capacity thereof, depending on the requirements for the respective clutch, in particular with respect to the application of energy, because otherwise the temperatures occurring when the multi-plate clutches 1, 2 are in operation would be too high.

There are likewise limits derived from the dimensional stability, in particular the flatness resulting from scalloping/cupping, e.g. when manipulating the components during assembly, in particular with respect to a tendency to bend unintentionally, or the rigidity of the plates, which affects the pressure distribution in the plate packet.

The outer plates 31, 32; 41, 42 of the multi-plate clutches 1; 2 have an outer toothing, which forms a connection to the common outer plate carrier 8 for conjoint rotation therewith. The friction plates 33; 43 of the multi-plate clutches 1; 2 have an inner toothing, which forms a connection to the associated inner plate carriers 11; 12 for conjoint rotation therewith.

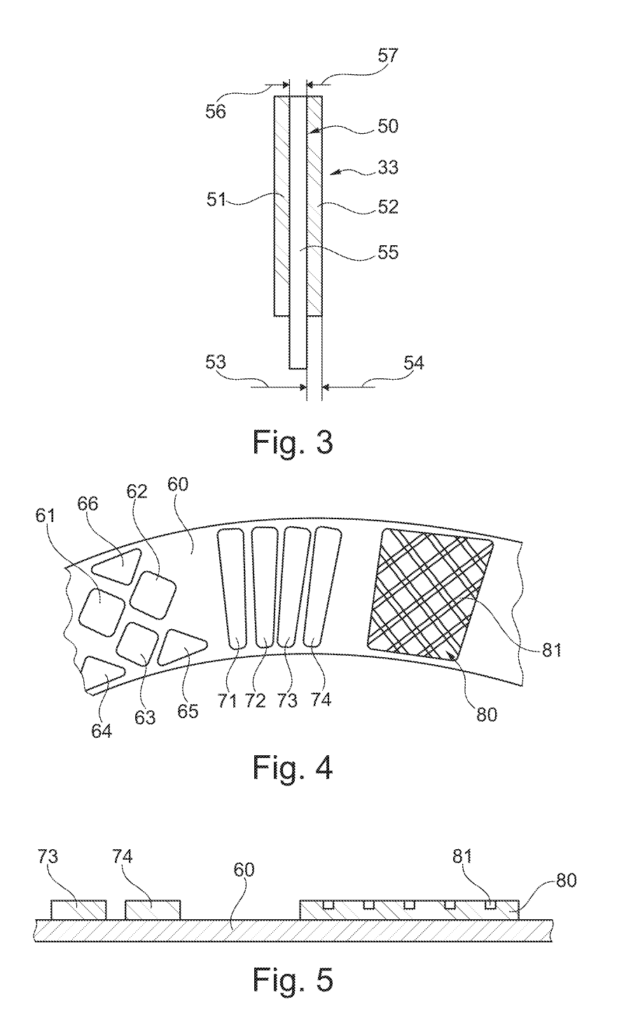

A friction plate 33 from FIG. 2 is shown in an enlarged cross section in FIG. 3. The friction plate 33 comprises a carrier element 50 with friction pads 51, 52 on two opposing sides thereof. The friction pads 51, 52 can be single or multi-part friction pads.

The friction pads 51, 52 are preferably paper pads. The paper pads 51, 52 are permanently connected to the carrier element 50 in a material bonded manner, e.g. with adhesive. The thickness of the friction pads 52 is indicated by the arrows 53, 54.

The carrier element 50 is, e.g. a carrier plate 55 with a defined thickness, indicated by the arrows 56, 57. The carrier plate 55 has an inner radial toothing, which forms a connection with the inner plate carrier (11 in FIG. 2) of the multi-plate clutch for conjoint rotation therewith.

As with the steel plates, the outer plates 31, 32; 41, 42, there are likewise lower limits for the thickness of the carrier element 50, in particular the carrier plate 55, specifically with respect to a surface pressure where the teeth come in contact therewith. The thickness 53, 54 of the friction pad 52 also affects drag torques occurring when in operation. Furthermore, the thickness 53, 54 of the friction pad 52 is a decisive parameter for the flow of fluid flowing through pad grooves when in operation thereof.

The radial flow of fluid from the interior toward the exterior follows certain principles in multi-plate clutches, resulting from the viscosity of the fluid or the rotation of the clutch components that convey the fluid and cause it to rotate. The fluid is part of a tribological system, also referred to (in German) as a “tribosystem,” comprising the multi-plate clutch together with the friction pad, normally made of paper, and the counter-plates or outer plates, normally in the form of steel plates.

Conventional friction pads are typically 0.75 millimeters thick. In order to reduce the axial installation space, it is possible to reduce the thickness of the friction pads, in particular the paper, when the groove design, or pad pattern of the grooves is modified as a counter measure, in order to not substantially limit the flow-through cross section, because this in turn could have a negative effect on the functioning of the multi-plate clutch, in particular with respect to drag torques, cooling, hydroplaning effects, and frictional coefficients.

Tests and studies have been carried out in the framework of the disclosure, regarding how an optimal relationship between the one-sided pad thickness, in particular the thickness of the friction pads 53, 54, to the thickness of the carrier plate 55 can be optimized. It has proven to be the case that a ratio of the friction pad thickness 53, 54 to the carrier plate thickness 56, 57 of 0.25 to 0.85 is optimal. In concrete applications, it is possible to implement a double-clutch in the available installation space with this ratio. By maintaining the optimal ratio, depending on the number of plates, numerous millimeters of space can be saved.

A section of a carrier element 60 is shown in FIGS. 4 and 5, seen from above. The carrier element 60 is a carrier plate, for example, as is indicated in FIG. 3 with the numeral 55. Friction pad segments 61 to 66; 71 to 74, and 80 are attached to the carrier element 60 such that a friction pad groove system is obtained. The friction pad segments 61 to 66; 71 to 74, and 80 are preferably permanently connected to the carrier element 60 in a material bonded manner, in particular using adhesive.

The friction pad segments 61 to 63 are substantially diamond-shaped. The friction pad segments 64 to 66 are substantially triangular. The friction pad segments 61 to 66 have rounded corners.

Parallel fluid channels are formed between the friction pad segments 61 to 66. The fluid channels are delimited by the carrier element and the friction pad segments 61 to 66, and are parallel to one another. The fluid channels are also referred to as grooves.

It should be ensured that there is a sufficient flow-through cross section for the necessary coolant volume in the design of the grooves, so that this fluid can flow through the plate packet, and not past it, or becoming backed up, resulting in an undesired hydroplaning of the friction pads.

Various groove designs are shown in FIG. 4. The friction pad segment 80 may be relatively large, with an embossed groove pattern 81, referred to as a waffle pattern. In contrast to the waffle pattern 81 for large friction pad segments, also referred to as individual pads, in which the waffle pattern is merely embossed, i.e. the waffle grooves are shallow, a groove design with smaller or narrower friction pad segments or individual pads is preferred when very thin friction pads are used. It is not necessary to over-emboss these, because the individual pads already exhibit a sufficiently small surface, and the depths of intermediate regions/grooves always reach the carrier element 60.

As a result, the flow-through cross section for the fluid can be maintained, despite a thinner pad, without changing the portion of grooves. The portion of grooves is the portion of the entire surface area of the friction plates that contains grooves and does not come in contact with the steel plate.

Because the surface pressure where the friction pad comes in contact with the steel plates cannot be arbitrarily increased, the portion of grooves can basically be maintained with thinner friction pads as well. Otherwise, an undesired increase in temperature at the frictional contact would result, or the surface area must be increased, which in turn would result in disadvantages with regard to the radial installation space.

The groove pattern formed with the friction pad segments 61 to 66 is also referred to as a rain tire pattern. This rain tire pattern has proven to be advantageous when combined with the claimed ratio of the friction pad thickness to the carrier plate thickness of 0.25 to 0.85.

Alternatively, a groove pattern with the narrower friction pad segments 70 to 74 has also proven to be advantageous. The course of the grooves, or the positions of the pads or friction pad segments 71 to 74 can also deviate from the radial outward direction, and be angled, for example.

The angle to the radial direction is advantageously selected depending on a rotational direction of the plates. With this angle, fluid can also be distributed circumferentially in a targeted manner, in order to obtain a better cooling effect over a larger area.

### LIST OF REFERENCE SYMBOLS

1 multi-plate clutch

2 multi-plate clutch

3 hub

4 hub

5 input element

6 bearing mechanism

7 bearing mechanism

8 outer plate carrier

9 bearing mechanism

10 double-clutch

11 inner plate carrier

12 inner plate carrier

13 rotational axis

15 support element

16 actuating element

17 spring element

18 actuating element

19 spring element

21 arrow

22 arrow

23 actuator bearing

24 actuator bearing

31 outer plate

32 outer plate

33 friction plate

41 outer plate

42 outer plate

43 friction plate

50 carrier element

51 friction pad

52 friction pad

53 arrow

54 arrow

55 carrier plate

56 arrow

57 arrow

60 carrier element

61 friction pad segment

62 friction pad segment

63 friction pad segment

64 friction pad segment

65 friction pad segment

66 friction pad segment

71 friction pad segment

72 friction pad segment

73 friction pad segment

74 friction pad segment

80 friction pad segment

81 groove pattern

1. A wet multi-plate clutch, comprising:
a plurality of friction plates that each include a carrier element with a carrier element thickness, and on which a least one friction pad is attached with a friction pad thickness, wherein the ratio of the friction pad thickness to the carrier element thickness is between 0.25 and 0.85.

2. The wet multi-plate clutch of claim 1, wherein the carrier element has friction pads on two opposing sides.

3. The wet multi-plate clutch of claim 1, wherein the friction plates are disposed radially, and alternate axially with counter-plates.

4. The wet multi-plate clutch of claim 1, wherein the multi-plate clutch is an axial double-clutch.

5. A wet multi-plate clutch, comprising: a plurality of friction plates that each include a carrier element with a carrier element thickness, and on which at least one friction pad is attached, which has a friction pad thickness, wherein the friction pad includes friction pad segments, between which parallel fluid channels are formed.

6. The wet multi-plate clutch of claim 5, the friction pad segments extend continuously, from a radial interior toward a radial exterior.

7. The wet multi-plate clutch of claim 5, wherein the friction pad segments have dimensions in a circumferential direction that are less than half of radial dimensions of the friction pad segments.

8. The wet multi-plate clutch of claim 5, wherein the fluid channels run in a radial direction.

9. The wet multi-plate clutch of claim 5, wherein the fluid channels are angled or at a diagonal to a radial direction.

10. (canceled)

11. A wet multi-plate clutch, comprising:
a first friction plate including a first carrier element with a first carrier element thickness, wherein the first friction plate further includes a first friction pad attached thereto, wherein the friction pad includes friction pad segments, between which parallel fluid channels are formed, wherein the first friction pad includes a first friction pad thickness, wherein a ratio of the friction pad thickness to the first carrier element thickness is between 0.25 and 0.85; and
a second friction plate including a second carrier element with a second carrier element thickness.

12. The wet multi-plate clutch of claim 11, wherein the first friction pad includes friction pad segments with parallel fluid channels formed therebetween.

13. The wet multi-plate clutch of claim 11, wherein the first carrier element is a carrier plate with an internal radial toothing for obtaining a connection to a plate carrier of the multi-plate clutch for conjoint rotation therewith.

14. The wet multi-plate clutch of claim 11, wherein the first carrier element is a carrier plate with an external radial toothing for obtaining a connection to a plate carrier of the multi-plate clutch for conjoint rotation therewith.

15. The wet multi-plate clutch of claim 11, wherein the friction pad thickness varies between 0.25 millimeters and 0.6 millimeters.

16. The wet multi-plate clutch of claim 11, wherein the first carrier plate thickness is derived from the friction pad thickness divided by the carrier element thickness and is between 0.9 millimeters and 0.7 millimeters.

17. The wet multi-plate clutch of claim 11, wherein the second friction plate includes a second friction pad on an opposing side of the first friction pad.

18. The wet multi-plate clutch of claim 17, wherein the first and second friction pad have a substantially equal thickness.

19. The wet multi-plate clutch of claim 11, wherein the first and second friction plates are disposed radially and alternate with one or more counter-plates along an axial direction.

20. The wet multi-plate clutch of claim 19, wherein the one or more counter-plates do not include friction pads.
